(19) United States
(12) Patent Application Publication
(10) Pub. No.: US 2015/0225223 A1
(43) Pub. Date: Aug. 13, 2015

(54) BEVERAGE DISPENSING MANAGEMENT SYSTEM

(71) Applicant: Manuel A. Morales Lema, San Juan, PR (US)

(72) Inventor: Manuel A. Morales Lema, San Juan, PR (US)

(21) Appl. No.: 14/620,776

(22) Filed: Feb. 12, 2015

Related U.S. Application Data
(60) Provisional application No. 61/938,878, filed on Feb. 12, 2014.

(51) Int. Cl. B67D 1/08; G05B 15/02

(52) U.S. Cl. CPC B67D 1/0888; G05B 15/02

(57) ABSTRACT

A drink serving management system comprising a drink vending machine and a portable device application which is used by a consumer for preordering a drink and making a payment before approaching to said drink vending machine. The consumer is able to pick up the drink and finish the transaction by scanning a unique identification to confirm the purchase. The drink vending machine and application will have an easy-to-use menu for choosing different types of drinks.

### STATEMENT REGARDING FEDERALLY SPONSORED RESEARCH AND DEVELOPMENT

N/A

### RELATED APPLICATIONS

N/A

### BACKGROUND OF THE INVENTION

### Field of the Invention

The invention is related to a method and apparatus for serving drinks but more specifically to a system for purchasing a drink at a mobile unit and picking said drink at a dispending unit.

### SUMMARY OF THE INVENTION

The present invention provides a method and apparatus for serving drinks in order to reduce working personal and waiting lines. One of the invention's objects is to allow a person/consumer to purchase a drink by said mobile device and pick the drink at a dispensing unit.

Another important aspect of the present invention is to provide a mobile application connected to network, wherein users may be aware of other users close area wherein a dispensing unit is located.

Further another important object of the invention is to provide a method for adding value to a personal account for drinks.

Yet another aspect of the invention is to provide purchase confirmation code used to redeem drinks.

Another important aspect of the present invention is to provide a mobile application connected to social network, wherein users may be aware of other users close area wherein a dispensing unit is located.

### BRIEF DESCRIPTION OF THE DRAWINGS

The accompanying drawings which are incorporated herein constitute part of the specifications and illustrate the preferred embodiment of the invention.

FIG. 1 shows the preferred embodiment of the present disclosure.

FIG. 2A-2B shows a general view of the mobile device interface for the preferred embodiment of the present disclosure.

FIG. 3A-3R shows a more detailed view of the mobile device interface for the preferred embodiment of the present disclosure.

FIG. 4A-4D shows a general view of the dispensing unit for the preferred embodiment of the present disclosure

FIG. 5 shows the dispensing unit delivering a fluid.

FIG. 6 shows at least one of the preferred embodiments for dispensing a fluid.

### DETAILED DESCRIPTION

The embodiments of the invention disclosed herein may be implemented, through the use of general-programming languages (such as C or C++). The program code can be disposed in any known computer-readable medium including semiconductor, magnetic disk, or optical disk (such as CD-ROM, DVD-ROM). As such, the code can be transmitted over communication networks including the Internet.

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system.

The embodiments are also directed to computer products, such as mobile devices, comprising software stored on any computer-usable medium, such as the memory of a mobile device. Such software, when executed in one or more data processing devices, causes a data processing device(s) to operate as described herein or, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

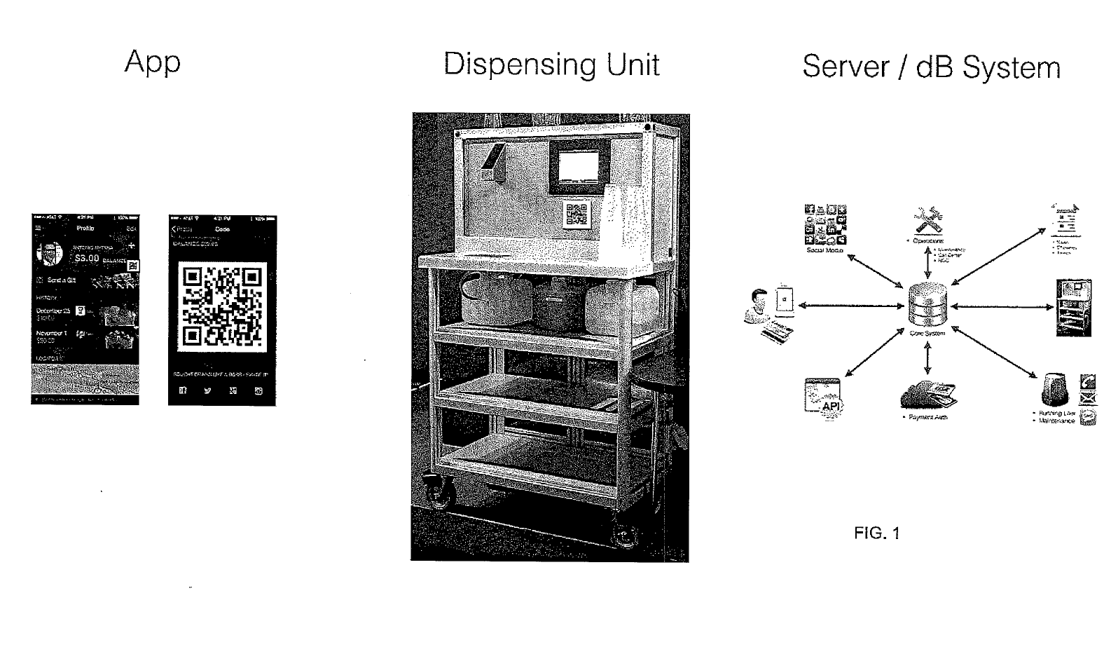

FIG. 1 is directed to the preferred embodiment of the present disclosure. The beverage dispensing management system and apparatus comprises at least a mobile device, a dispensing unit and a sever or data base system. The mobile device, dispensing unit and sever are connected through a communication medium in order to share information regarding purchases, availability or product, users location, send message and others.

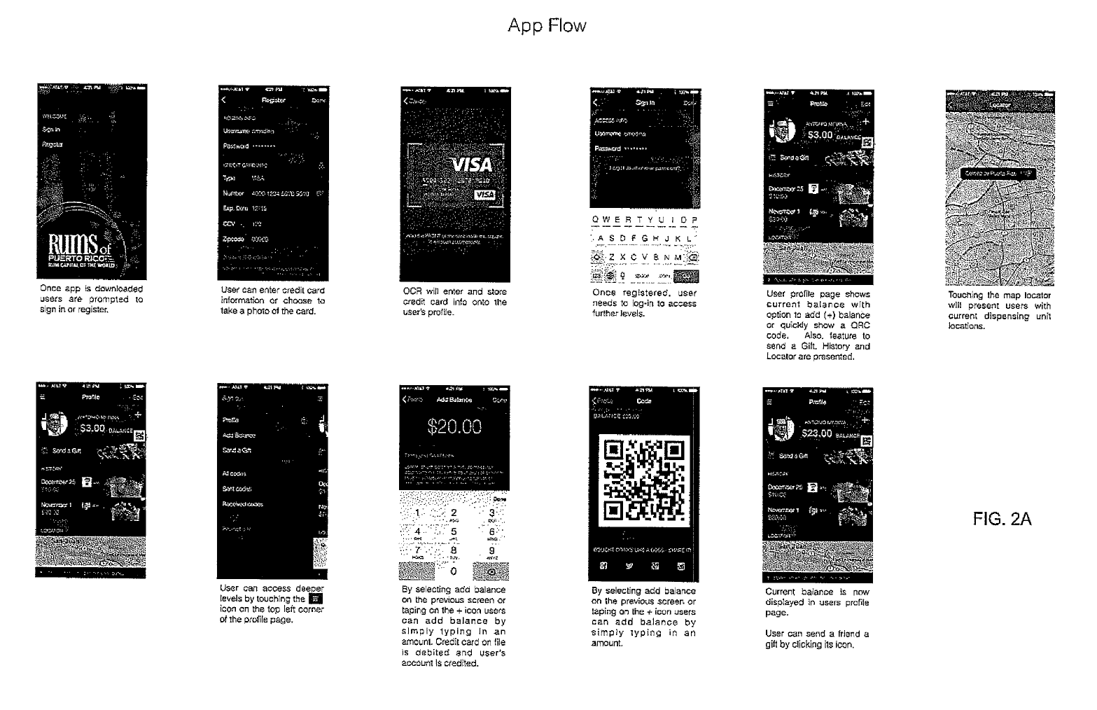

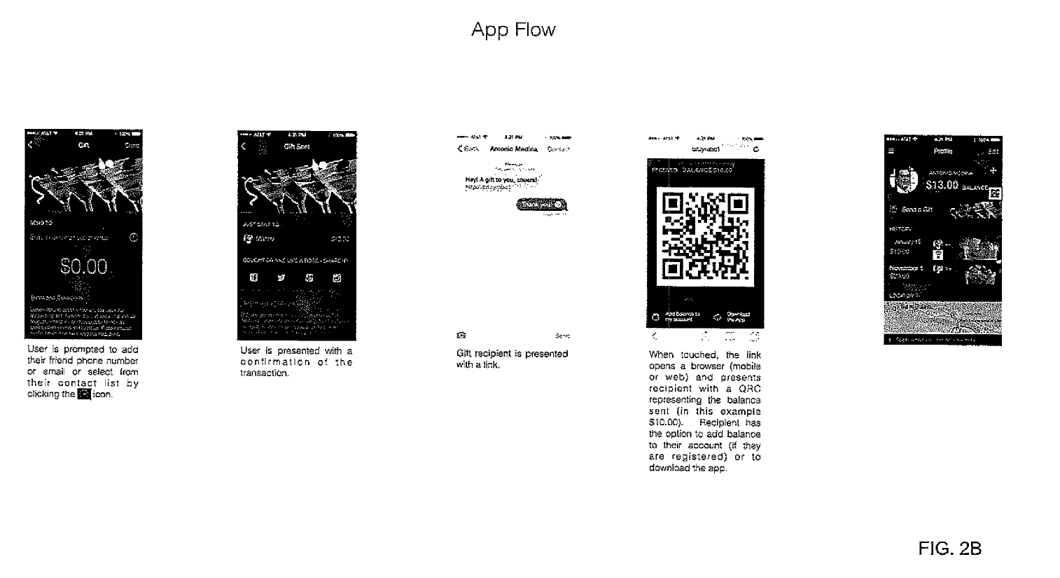

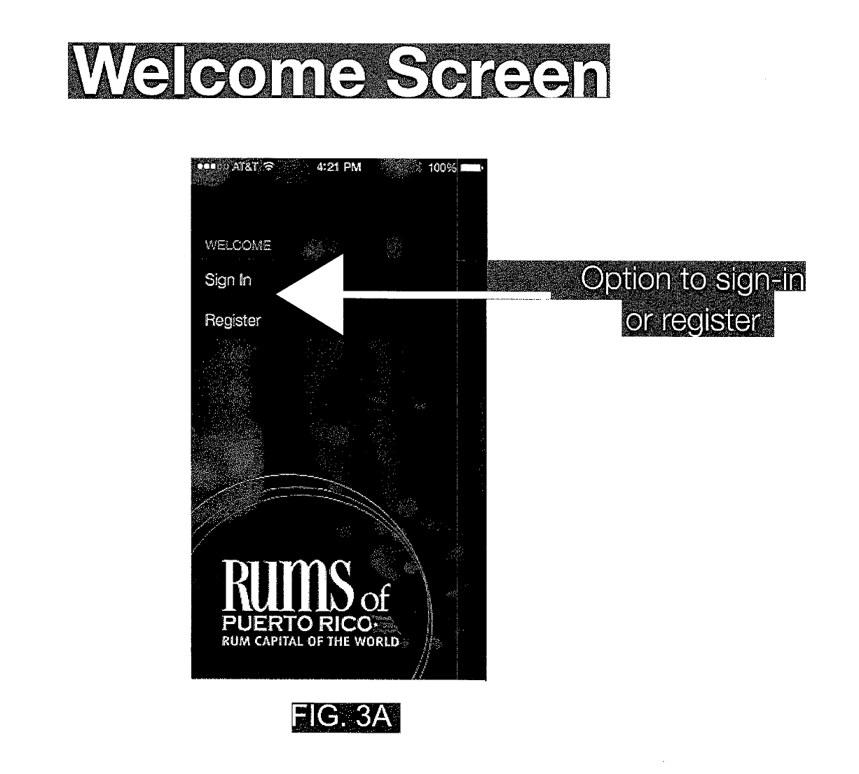

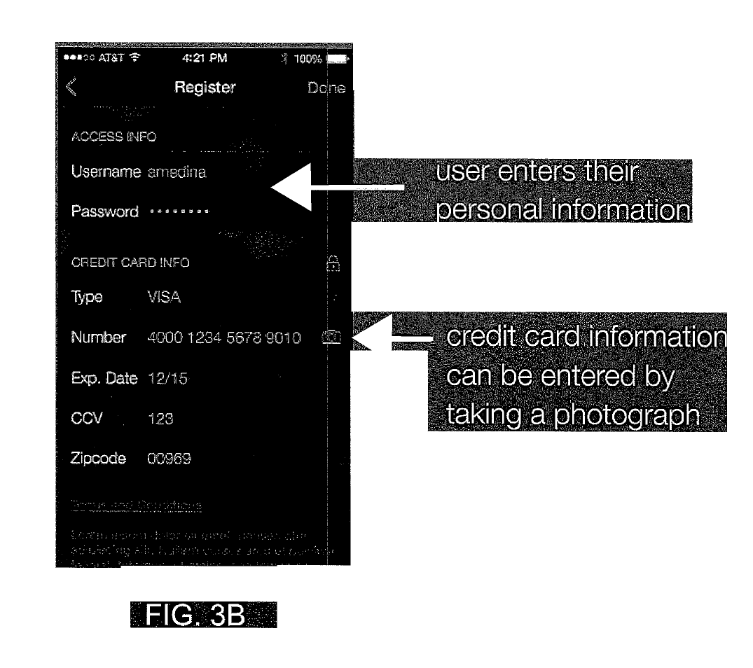

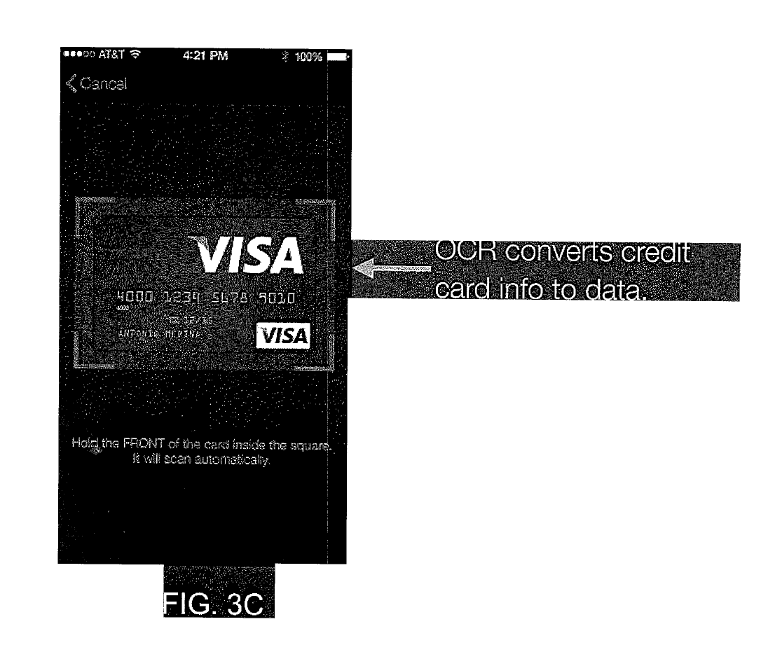

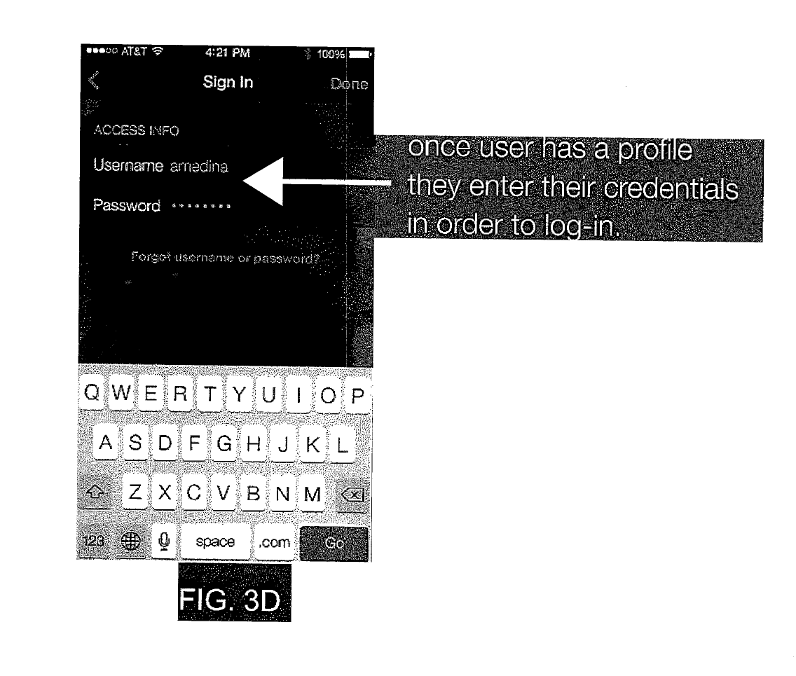

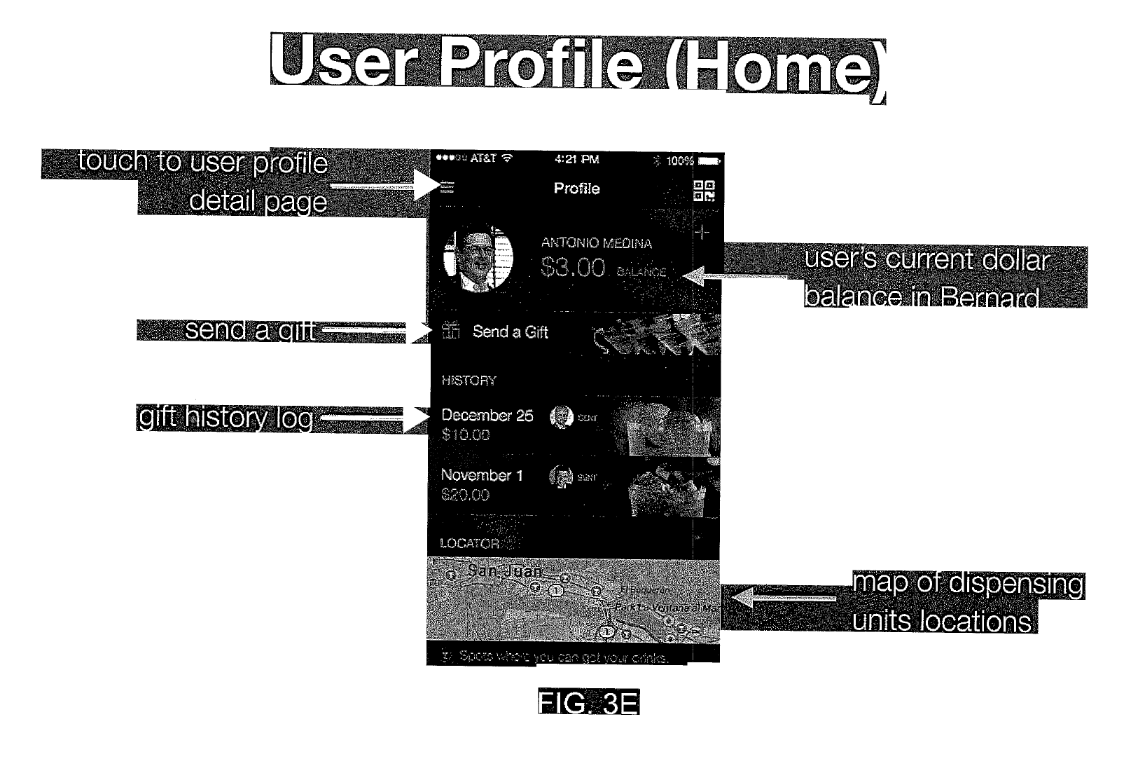

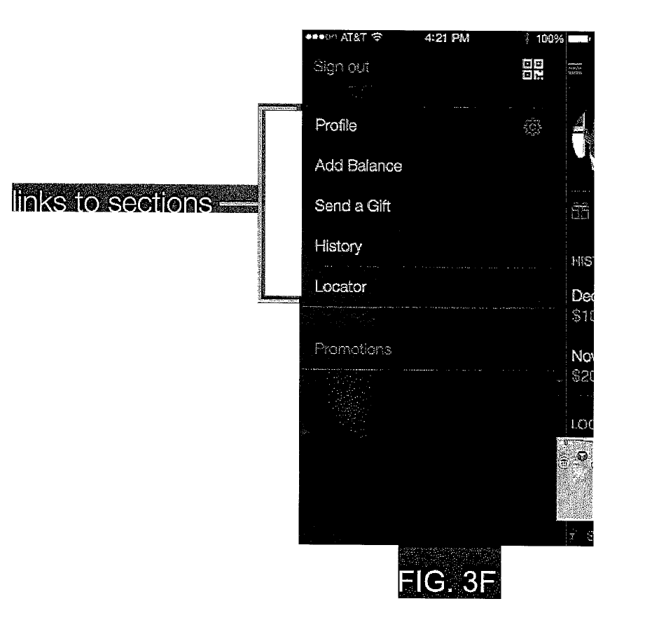

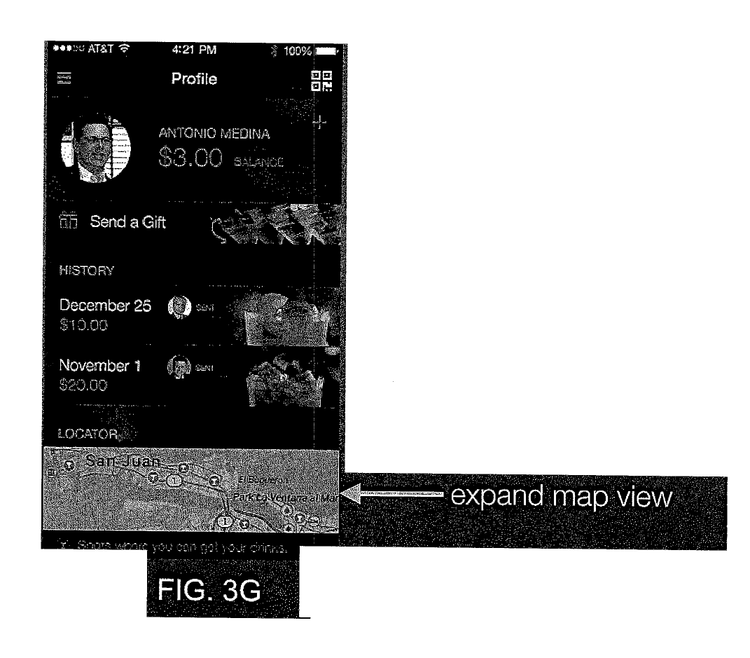

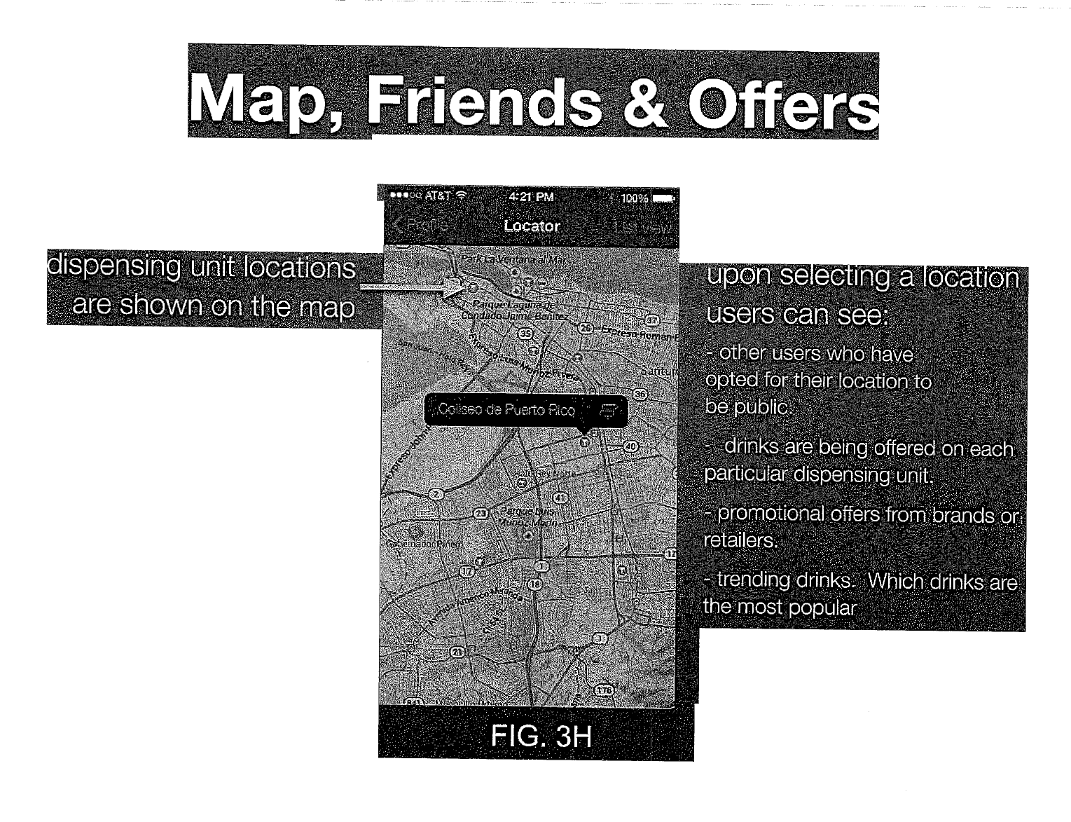

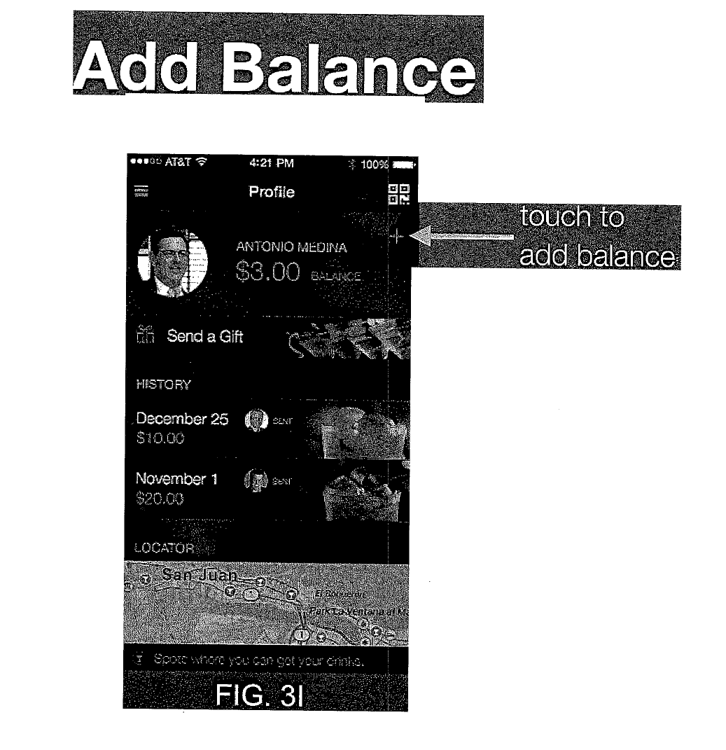

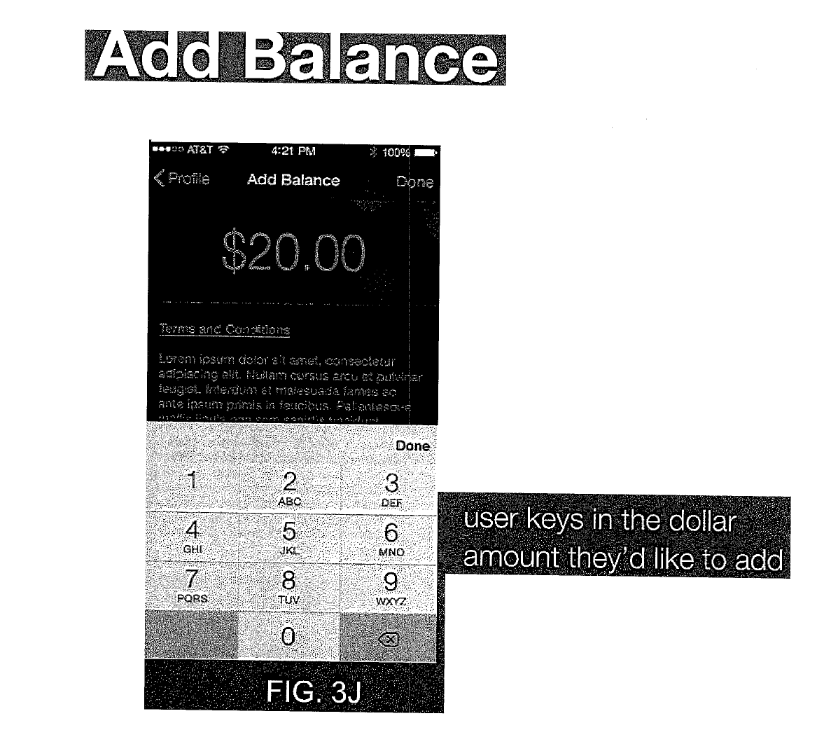

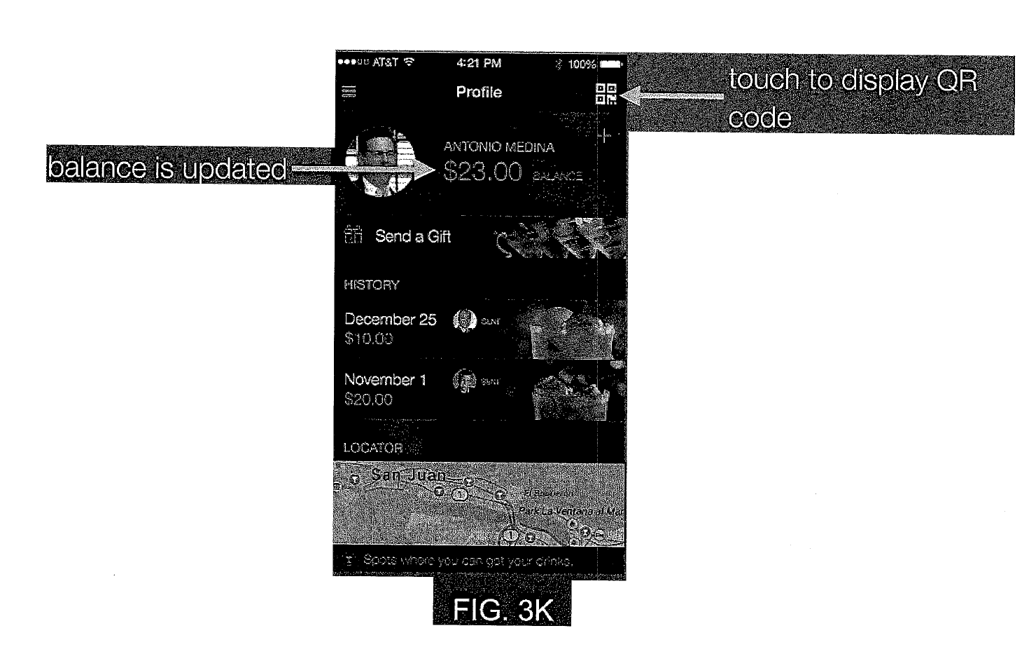

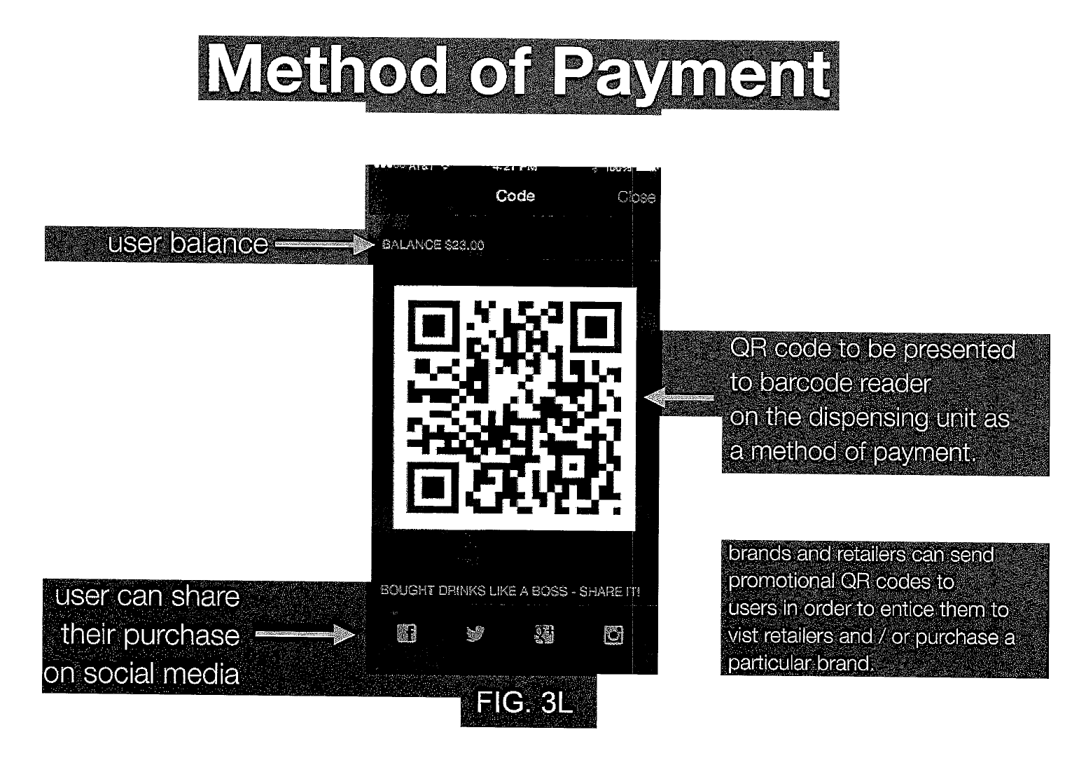

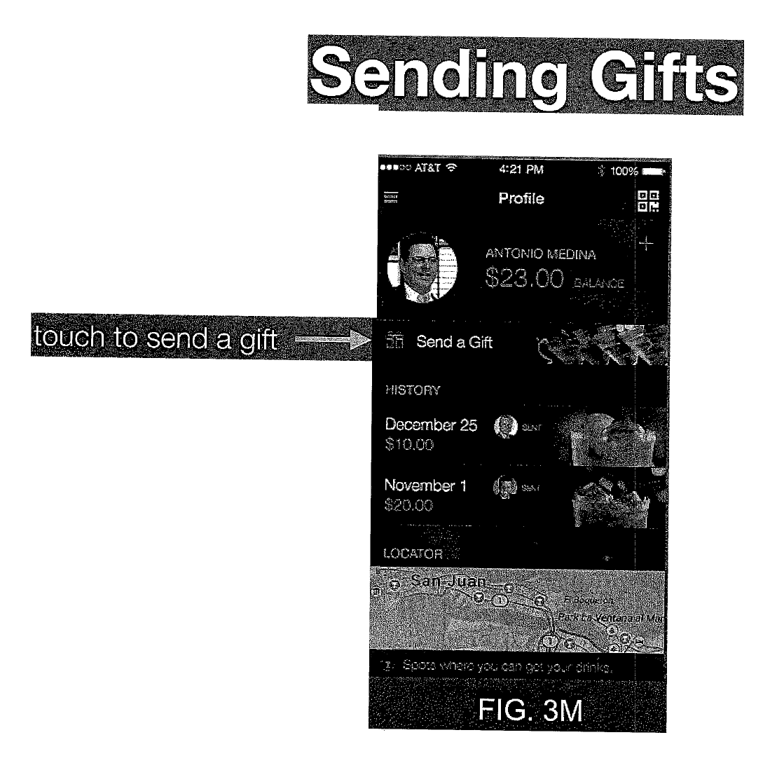

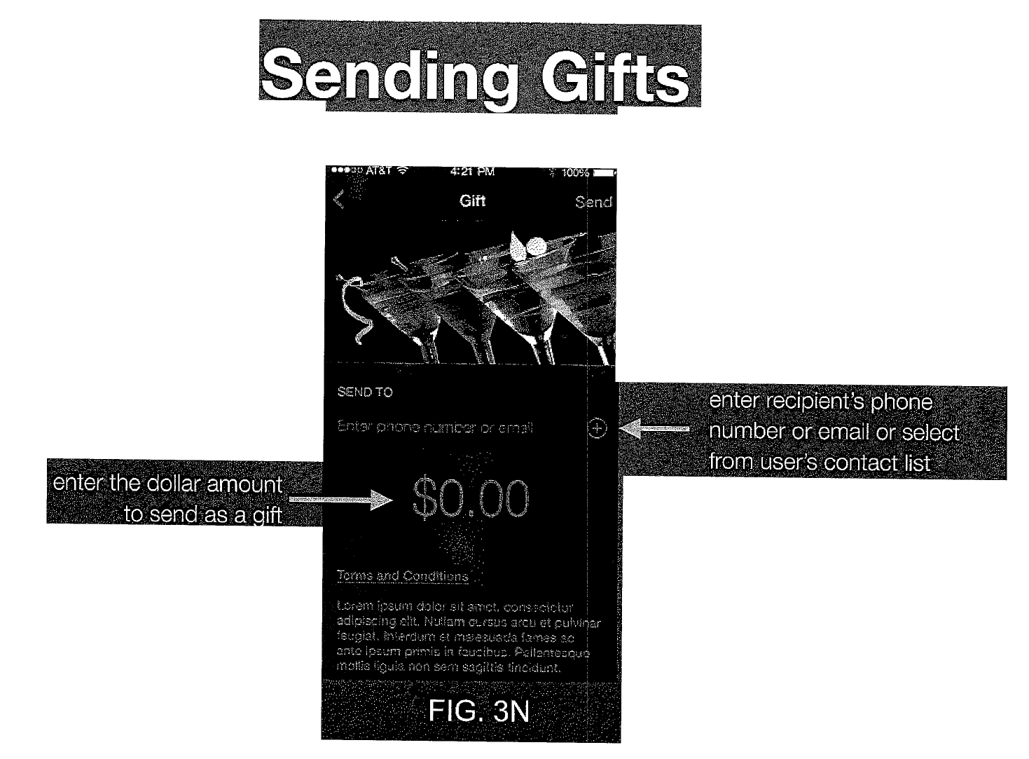

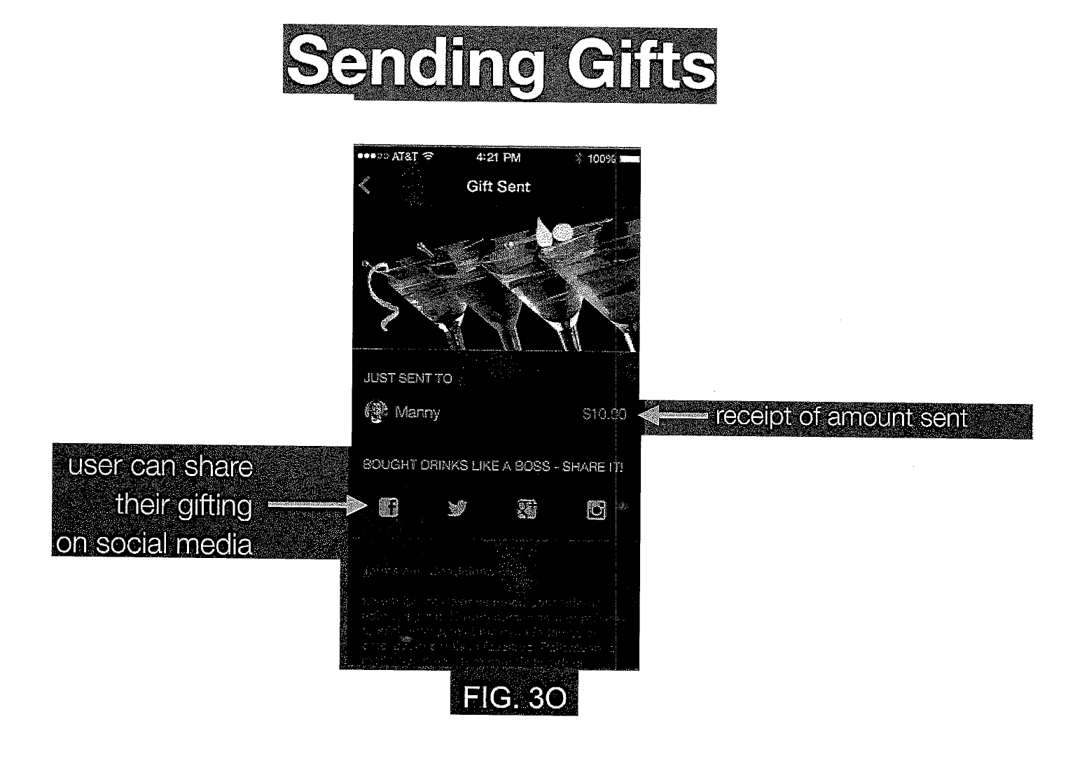

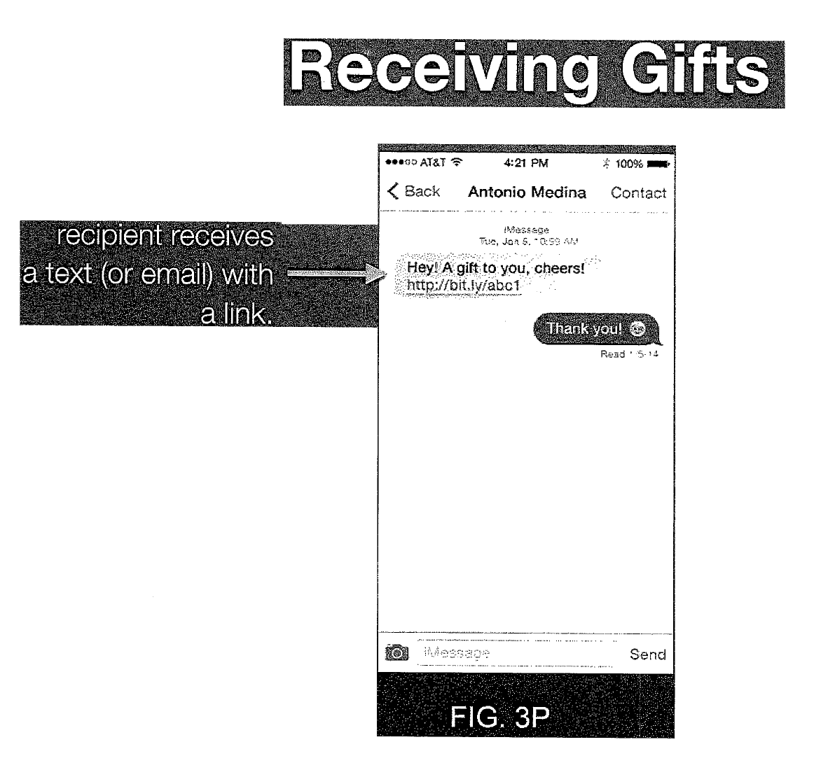

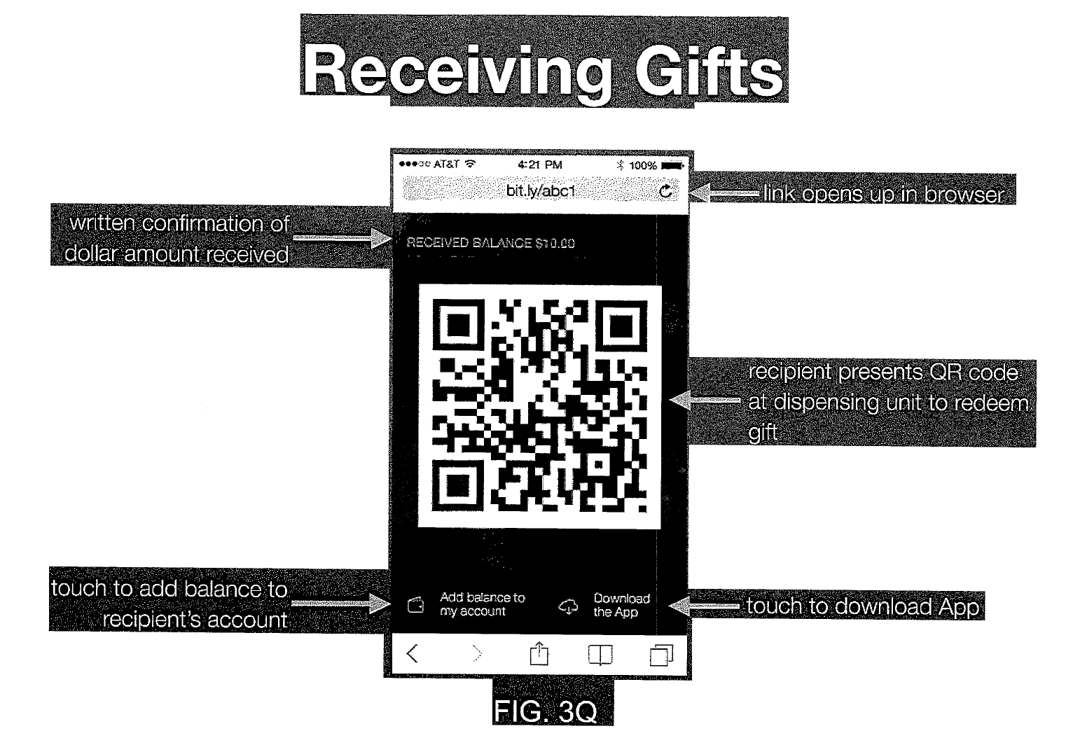

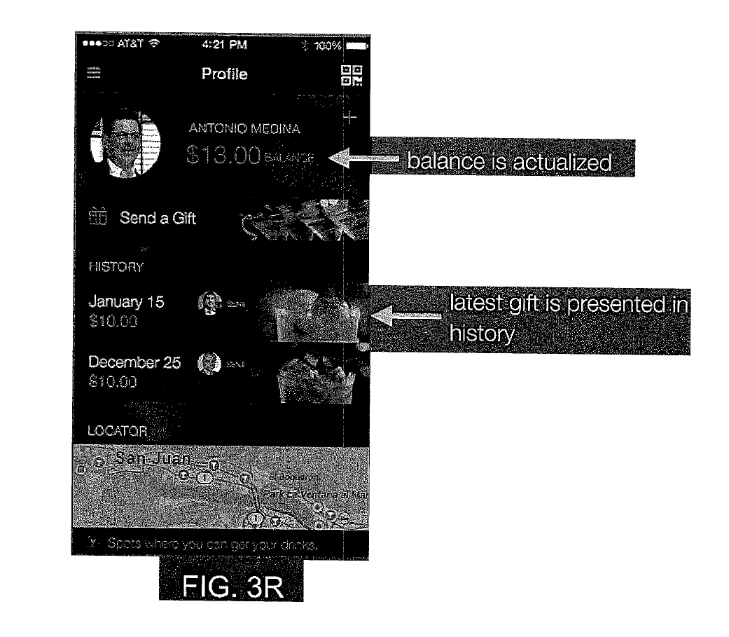

A mobile device comprising a software stored on any computer-usable medium is used to performed several action in order to provide communication between the server, wherein said server also comprises a software, compatible with the mobile device, on any computer-usable medium. The software at the mobile device executed, in one or more data processing devices, several action. FIG. 2A-2B are directed to general view of the mobile device interface for the preferred embodiment of the present disclosure. The interfaces are directed to a particular action performed by the mobile device software. Some of the executed action, as shown in FIG. 3A-3R are:

### Registration Process

During this process the user create an account by adding personal information, password and payment method, such as credit cards, debits card and others. Several processes, such as convert credit card information into data can be performed at this action.

### Profile Configuration

The user may configure the personal account in other to add value to his account. Further, user can made public his location and/or send message a digital confirmation of the purchases of a drink.

### Finding Friends, Map and Offers

The user may found other user and/or friends and their locations in order to invite drinks, dispensing unit locations and others.

### Add Balance

The user may add value to his account.

### Method of Payment

After purchasing any amount of drinks a code is generated. The purpose of the code is to provide evidence of payment in order to redeem said purchase. The code can be share through any social network and/or message. The code is shared between the server in order to verify purchase at the point of sale.

### Sending Gifts/Receiving Gift

User may send a code by any communication medium to another user. The code might be received as a link. The link serves to access the server in order to upload the code and redeem it.

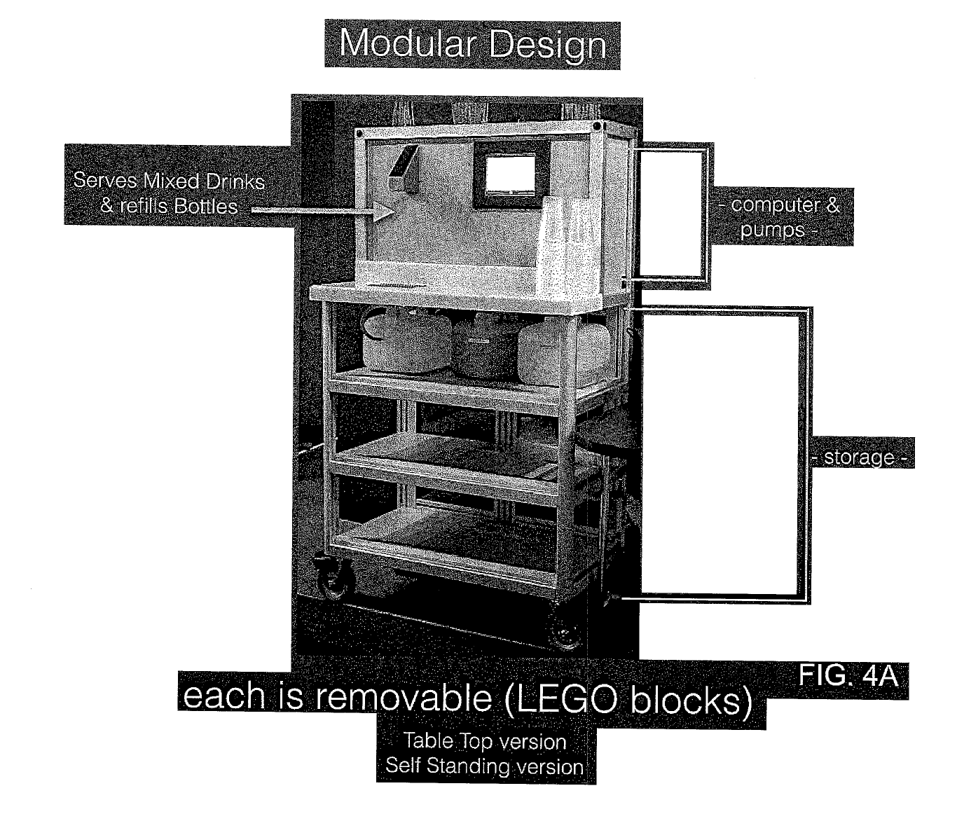

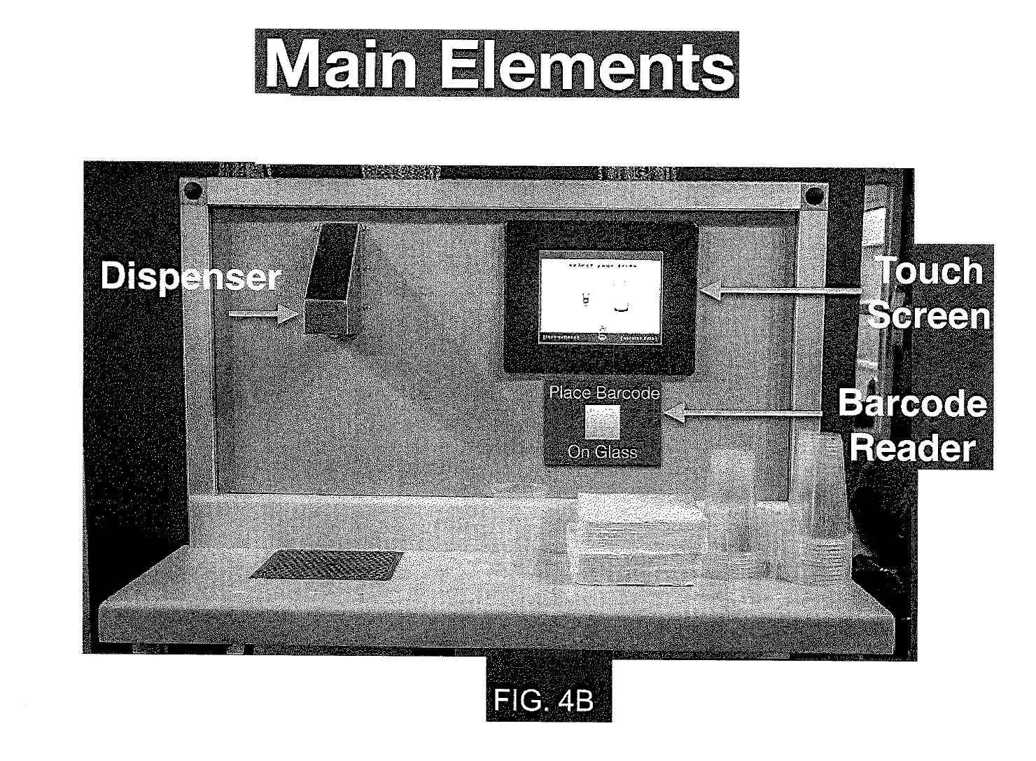

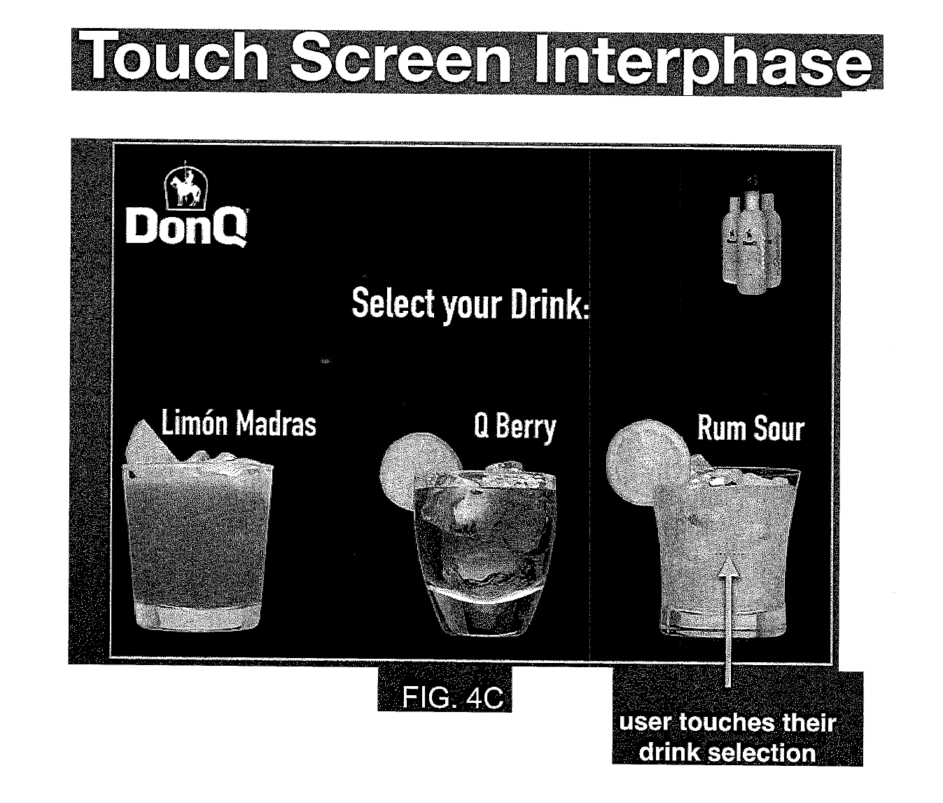

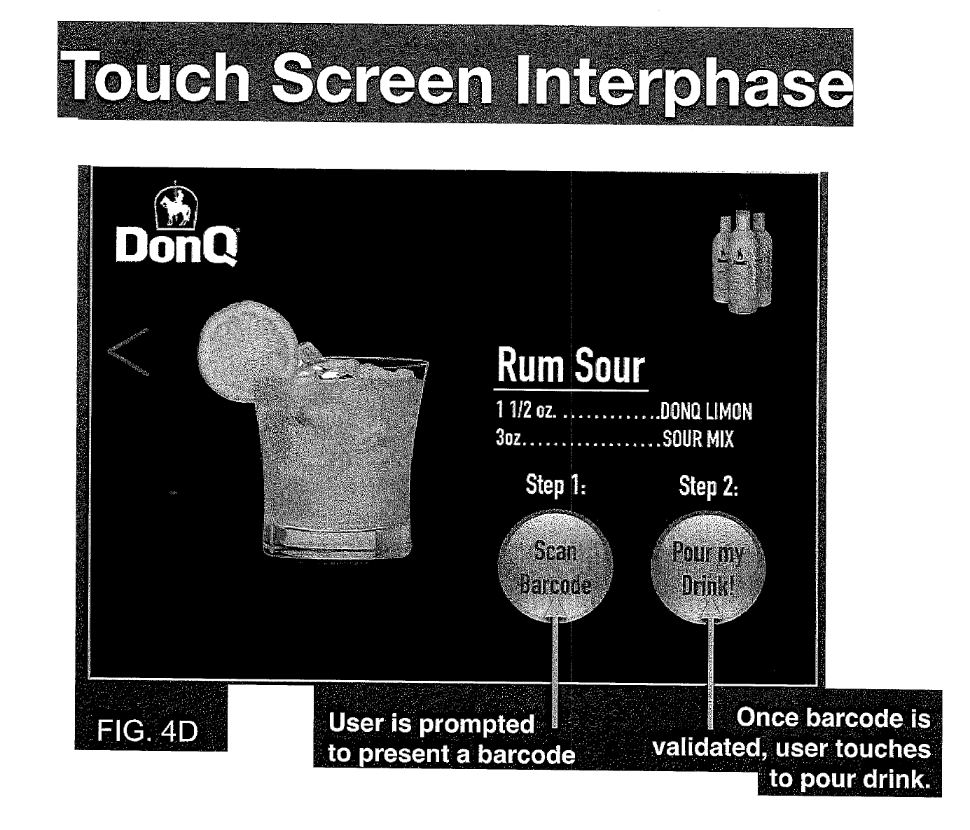

FIG. 4A-4C discloses a general view of the dispensing unit for the preferred embodiment of the present disclosure. The mobile dispensing unit comprises at least a touch screen, a bar code reader and a dispenser. Further ti comprises several pumps, storage for beverages, a computer product with a software to provide reading and dispensing actions. The dispensing unit is in communication with the server in order to verify barcodes, provide information about products available and location. Further information about drinks are display at the touch screen for the user selection in order to redeem the gift or gift information in the form of a bar code.

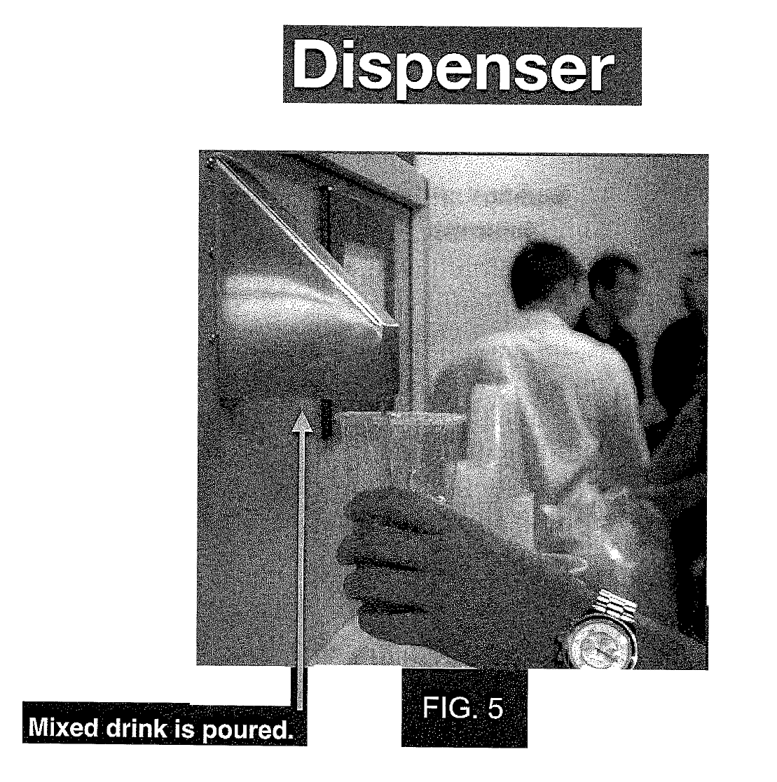

Once the drink is selected and the process is completed a drink is served, as shown in FIG. 5. Once the drink is delivered the information at the server is updated. Further the system may include a set of instruction for informing the user of the bar code used or redeemed.

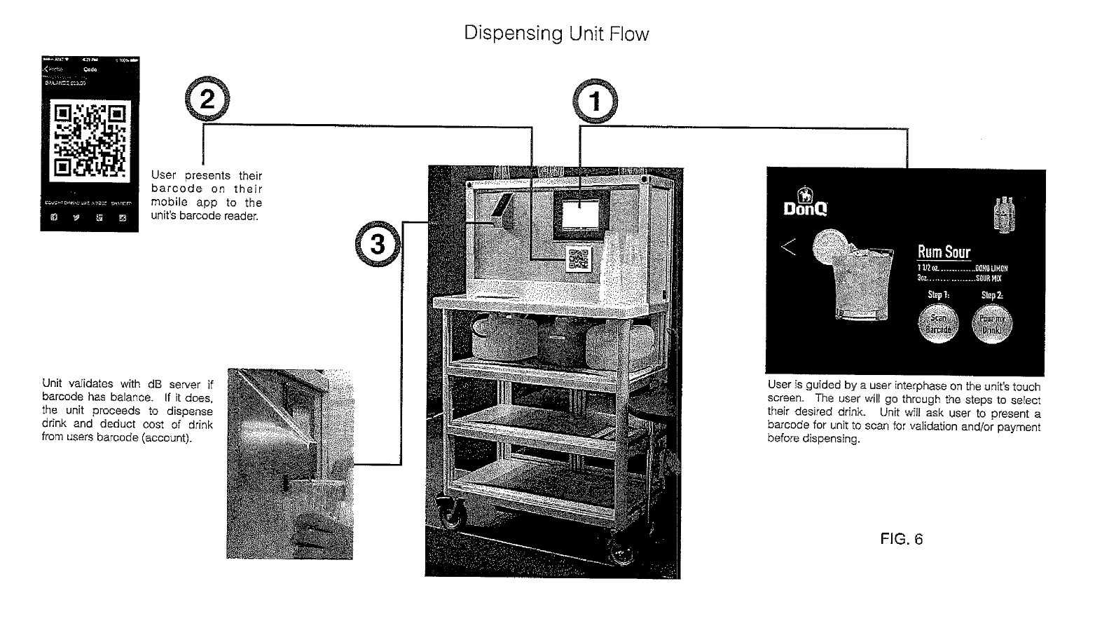

FIG. 6 is directed at least one of the preferred embodiments for dispensing a fluid. First the user selects the drink; further, user pays for the drink by scanning the bar code generated by the software. Then the drink is served.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A beverage dispending management system comprising:
a network;
a first communication device for a sender user;
a second communication device for a receiver user;
a dispenser unit comprising a input unit, a signal reader and a dispenser;
computing unit a first data base;
wherein said computing unit comprises a first set of instructions for purchasing a first item using a first communication device;
wherein said computing unit comprises a second set of instructions for generating a particular code;
wherein said computing unit comprises a third set of instructions for sending said particular code to said second wireless communication device though said network;
said second wireless communication device generating a readable signal;
said dispenser reading said readable signal;
said dispenser exchanging information with the computing unit through the network;
wherein said computing unit comprises a fourth set of instructions for validating said readable signal;
wherein said computing unit comprises a fifth set of instructions for generating an second code to said dispenser unit; and
wherein said dispenser unit selects dispensing said first item based on said second code.

2. The beverage dispending management system as in claim 1, wherein said readable signal is a bar code.

3. The beverage dispending management system as in claim 1, wherein said input unit is a touch screen unit; and said signal reader is a bar code reader.

4. The beverage dispending management system as in claim 1, wherein said comprises is an approved signal.

5. The beverage dispending management system as in claim 1, wherein said comprises is an no-approved signal.

6. The beverage dispending management system as in claim 1, wherein said first communication device is the same as the second communication device; and wherein said sender user is the same as the receiver user.
